(19) United States
(12) Patent Application Publication
(10) Pub. No.: US 2008/0005332 A1
(43) Pub. Date: Jan. 3, 2008

(54) Method for Opportunistic Computing

(75) Inventors: Santosh Pande, Norcross, GA (US); Romain E. Cledat, Atlanta, GA (US); Tushar Kumar, Atlanta, GA (US); Jaswanth Sreeram, Atlanta, GA (US)

Correspondence Address: BRYAN W. BOCKHOP, ESQ.;BOCKHOP & ASSOCIATES, LLC, 2375 MOSSY BRANCH DR., SNELLVILLE, GA, 30078, US

(73) Assignee: GEORGIA TECH RESEARCH CORPORATION, Atlanta, GA (US)

(21) Appl. No.: 11/759,200

(22) Filed: Jun. 6, 2007

Related U.S. Application Data
(60) Provisional application No. 60/812,010, filed on Jun. 8, 2006.

(51) Int. Cl. G06F 15/173

(52) U.S. Cl. 709/226

(57) ABSTRACT

In a method of dynamically changing a computation performed by an application executing on a digital computer, the application is characterized in terms of slack and workloads of underlying components of the application and of interactions therebetween. The application is enhanced dynamically based on predictive models generated from the characterizing action and on the dynamic availability of computational resources. Strictness of data consistency constraints is adjusted dynamically between threads in the application, thereby providing runtime control mechanisms for dynamically enhancing the application.

### CROSS-REFERENCE TO RELATED APPLICATION

This application claims the benefit of U.S. Provisional Patent Application Ser. No. 60/812,010, filed Jun. 8, 2006, the entirety of which is hereby incorporated herein by reference.

### STATEMENT OF GOVERNMENT INTEREST

This invention was made with support from the U.S. government under grant number C-49-611, awarded by the National Science Foundation. The government may have certain rights in the invention.

### BACKGROUND OF THE INVENTION

1. Field of the Invention

The present invention relates to computational systems and, more specifically, to a computational system that dynamically adjusts the computation performed by an application in a manner that best utilizes available computational resources.

2. Description of the Prior Art

As the demand for powerful CPUs continues to rise, the clock frequency and density of transistors achievable on a single processor core with contemporary technology have approached physical limits. To meet the increasing demand, chip makers are packing an increasing number of cores on a chip so as to avoid the transistor density limits while trying to balance performance and power considerations. Beyond the current multicore platforms, such as the dual core Intel Conroe and the 9-core IBM Cell processor, chips with tens of cores will likely be available in the near future. While multi-processor architectures have been used in servers and workstations, they are rapidly moving towards becoming “standard equipment” in personal computing platforms such as desktops, game consoles, lap-tops and even future cell-phones.

The introduction of multicore processors on desktops and other personal computing platforms has given rise to multiple interesting end-user application possibilities. One important trend is the increased presence of resource-hungry applications like gaming and multimedia applications. One of the distinguishing factors of these applications is that they are amenable to variable semantics (i.e., multiple possibilities of results) unlike traditional applications wherein a fixed, unique answer is expected. For example, a higher degree of image processing improves picture quality; however, a lower level of picture quality may be acceptable. Similarly, different model complexities used in game physics calculations allow different degrees of realism during game-play.

Current programming models are limited in their ability to express the morphability (ability to undertake dynamic changes) of computations. Morphability allows the underlying program to scale dynamically with the available resources of the platform. Given the rapid evolution of multicore processors from present day dual cores to a predicted 100 cores by 2011, there is a need for computing approaches that offer a scaling of application semantics with the processor's power.

Traditional applications on a home PC relied on the fact that the number of transistors per square inch would scale according to Moore's law and translate in an increase in frequency. Programmers have thus been able to program applications that run faster and better without dramatically changing their way of thinking about the structure of the application. This scenario seems to be undergoing a rapid change. Application designers, rather than relying on improvements in clock speed, are learning to use more resources; instead of exploiting one resource to the maximum, they are beginning to exploit many resources (i.e., several different cores).

Concurrent to this shift in the architectural perspective, applications have also undergone an evolution. Computers have moved from being the sole domain of office workers to hosting games and multimedia applications or more specifically they support what are called “immersive environments.” Computers are no longer being considered synonymous with PCs, but are distributed as game consoles, cell phones and other devices on which users wish to run different applications as compare to those traditionally used in the office. Although the application domain is ever changing, certain trends can be analyzed: a greater connectivity and a greater level of immersion.

Newer applications like games stress on the need to make the user feel as immersed in the application as possible. The immersion present in these newer applications exposes a characteristic that most classical applications did not: variable semantics. With variable semantics, there can be multiple correct solutions for a given problem. In games, for example, the artificial intelligence (AI) entities that operate certain elements of the game can be of varying quality. More realistic effects can be added to make the game appear closer to reality. As an illustration, a more precise modeling of the human body can be used to calculate how a character moves down stairs (in most games, the feet “hang” in the air, however more precise calculation can make this effect go away). In video coding, the way in which one encodes an image is variable. For example, the MPEG format has three types of frames (I, P, or B). The percentage of use of each of these types of frames can result in variations with respect to the encoded size and decoding time. Given more resources, higher quality and more interesting processing can be done as a part of these applications' semantics.

Traditional approaches from parallel computing (or new multicore computing) for scaling the performance of a fixed application with the number of cores is complex and generally leads to incremental improvement. Traditional approaches usually involve finding parallelism in a program and multi-threading it. However, due to the sharing of state between threads, it is difficult to parallelize them beyond a certain extent.

Therefore, there is a need to make use of the multiple cores and extra resources to improve the quality of the multicore applications.

### SUMMARY OF THE INVENTION

The disadvantages of the prior art are overcome by the present invention which, in one aspect, is a method of dynamically changing a computation performed by an application executing on a digital computer in which the application is characterized in terms of slack and workloads of underlying components of the application and of interactions therebetween. The application is enhanced dynamically based on the results of the characterizing action and on dynamic availability of computational resources. Strictness of data consistency constraints is adjusted dynamically between threads in the application, thereby providing runtime control mechanisms for dynamically enhancing the application.

In another aspect, the invention is a method of characterizing an application, configured to execute on a digital computer, in terms of slack and workloads of underlying components of the application and of interactions therebetween. A profiling analysis of the application is performed. A statistical correlation and classification analysis of the application is also performed. The profiling analysis and the statistical correlation and classification analysis result in characterization of the application.

In another aspect, the invention is a method of enhancing an application, configured to execute on a digital computer, dynamically, in which the application is monitored and slack is detected. An enhancement paradigm is applied to the application in response to the detection of slack.

In another aspect, the invention is a method of adjusting strictness of consistency constraints dynamically between threads in an application configured to execute on a digital computer in which data shared between threads are grouped into shared-data groups. Data consistency properties of the shared data groups are relaxed thereby lowering conflicts among threads sharing data. Lowering of conflicts between threads is used to provide additional flexibility for enhancing the application dynamically to meet enhancement objectives, subject to correctness constraints provided by a programmer.

In another aspect, the invention is a method of computing an application on a digital computer in which a probabilistic model that execution units of the application will exhibit slack during execution of the application on at least one computational unit is determined. The probabilistic model is utilized to enhance the application when the model predicts that future execution of an execution unit is expected to exhibit a desired amount of slack.

In another aspect, the invention is a method of opportunistic computing of an application on a digital computer in which the application is profiled so as to create a context execution tree that includes a plurality of executable units within the application. The sequencing and organization of the plurality of executable units in the context execution tree captures the statistical and programmatic ordering properties of the plurality of execution units. The plurality of executable units is analyzed statistically to identify a plurality of indicators in the application. Each indicator indicates whether an executable unit will exhibit slack with a predetermined statistical confidence when it is executed in the context of surrounding or enclosing executable units. Indicators are detected during the execution of the application and thereby the executable units in which slack has been predicted within a predetermined probabilistic model are identified. The executable units identified in the detecting step trigger the execution of an extended executable unit in order to enhance the application. The degree and extent of the extended executable unit executed is limited by the computational resources available at that point, or expected to be available in a suitable window of time in the future.

In yet another aspect, the invention is a method of generating code for an application designed to execute on a digital computer in which a primary set of instructions necessary for the application to operate is encoded at a basic level. A secondary set of instructions that include enhancements to the primary set of instructions is generated. A plurality which of the secondary set of instructions are to be executed in response to a runtime indication that a computational resource is underutilized are indicated in the application.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a block diagram showing relationships between several aspects of one representative embodiment.

FIGS. 2A-2C are block diagrams forms of enhancing an application.

FIG. 3 is a diagram showing formation of a tree structure used in analysis of an application.

FIG. 4 is a listing of an algorithm that is used to construct a CET.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Also, as used herein, “enhancement paradigm” refers to a system for enacting enhancement objectives.

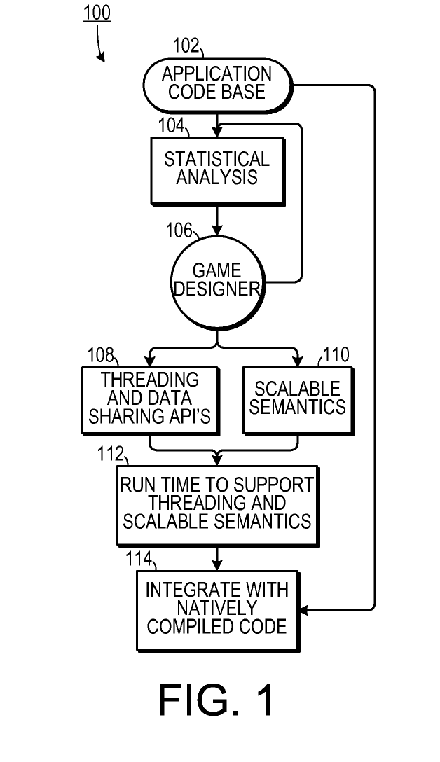

As shown in FIG. 1, one embodiment starts with an application code base 102 upon which it performs a statistical analysis 104. This is performed with input from the designer 106. The designer employs threading and data sharing API's 108 and scalable semantics 110. A run time supports the threading and scalable semantics 112 to integrate with the application code base 102 to achieve natively compiled code.

In one embodiment, the present invention allows the specification of scalable semantics in applications that can be enriched and thus adapt to the amount of available resources at runtime. The embodiment employs a C/C++ API that allows the programmer to define how the current semantics of a program can be opportunistically enriched, as well as the underlying runtime system that orchestrates the different computations. This infrastructure can be used, for example, to enrich well known games, such as “Quake 3” on Intel dual core machines. It is possible to perform significant enrichment by utilizing the additional core on the machine.

Scientific codes scale very well to a large number of processors or cores. However, applications where parallelism is harder to find and express tend to lag behind. Some applications that lack clearly identifiable independent threads are difficult to parallelize. Data parallelism is also a way to circumvent the difficulties of functional threading but has its limits: data needs to be divided in independent pieces and data reorganization cost is high. Fortunately, new domains have opened in which parallel computing is getting deployed especially in a personal computing environment. One such domain is interactive, soft-real time systems such as gaming and interactive multi-media. In this domain, extra processing power can be deployed in a creative manner. Not by speeding up a fixed computation, but rather by creating a better computation within the constraints of soft deadlines.

One embodiment focuses on an application's semantics instead of focusing on parallelizing algorithms and programs. The approach is centered on the user specifying different levels of quality for data at different points in the program. A runtime will try to meet these requirements given the time constraints imposed on it (for example, in a game, all processing for a frame must be done under a certain amount of time to maintain a certain frame rate). The programmer also informs the runtime of the ways in which it can modify quality for data values. The runtime will use both the requirements and the methods given to it to transform data to determine the best execution path for the program to try to meet all the programmer's needs while meeting time constraints. This approach is particularly functional when combined with the notion of variable semantics as the runtime has more options to compute valid results.

The programmer can specify a range of options between best-case scenarios (e.g., by supposing the machine the application is running on is high-end) and minimum scenarios (e.g., by supposing that the machine is low-end). The runtime will then pick the best possible answer from this range of scenarios given the time constraints, resource availability and execution context of the application. The programmer does not have to worry about which computation gets invoked to produce the result; he just specifies which results are acceptable and the runtime will produce one such result.

Opportunistic Computing: A New Model: New domains have opened in which parallel computing is getting deployed especially in a personal computing environment. One such domain is interactive, soft-real time systems such as gaming and interactive multi-media. In this domain, extra processing power could be deployed in a creative manner—not speeding up a fixed computation, but rather creating a better computation within the constraints of the soft deadline.

One embodiment allows the programmer to exploit fully multiple cores by thinking in terms of extensible semantics which is valuable to the domain specific needs rather than the operational manner of parallelizing his application. In the system, a runtime decides which computations to launch in parallel. The programmer specifies main tasks (either a single-thread or simple multi-threads) and possible computations and the runtime will launch the possible computations at appropriate times.

One embodiment allows an application to scale in terms of its semantics or functionality during its execution (to better adapt to the execution environment), and during its lifetime (when machines become even more parallel). It is important to note that, even if an application is running on a machine where no other application is running, it will still exhibit different needs depending on its exact point of execution and input data. The application can thus also scale in response to its current input data set and execution needs. This embodiment re-centers programming around what an application is doing and what results it needs to produce.

One embodiment employs opportunistic computing to attempt to exploit all resources in a machine providing the operational vehicle for implementing variable semantics. A new model can help utilize all cores without explicitly having to parallelize their code. Opportunity, in this context, refers to unused capacities (resource-wise or time-wise) that a program may tap into to perform extra or more intensive tasks. Opportunity goes hand in hand with the notion of deadlines: a program that runs as fast as possible using all possible resources all the time exhibits no opportunities. However, a program like a game, in which executing as fast as possible is not the objective, is prone to using a subset of available resources. In particular, game consoles are dimensioned to allow the most intensive part of games to run without any visible performance glitches—they are geared towards the worst case scenario in some sense so as not to degrade user experience. In addition, significant execution time variances exist during the game play. For example, from scene to scene, physics and artificial (AI) computations can vary dramatically depending on the complexities of the scene, or events that have taken place prior to the scene update (such as shooting a weapon versus simply following the enemy). Therefore, game design and platforms allow for considerable opportunities during execution where resource demands are less than peak.

Opportunistic computing aims at making full use of the resources that have become available at runtime by dynamically allowing modification of program semantics. Various opportunities may be exploited, including:

Resource dependent opportunities: On a time shared platform (PCs already follow this model, future consoles are emerging into this model since they will be the hubs of home entertainment systems) other concurrent applications may be taking up resources periodically and then releasing them. As resources become available, the runtime dynamically extends the program to take advantage of these new resources. It should also be able to scale down as resources are taken away (by other programs starting to run for example) by canceling optional tasks.

Time dependent opportunities: Independent of resource availability, another form of opportunity exists: opportunity based on tasks taking less time than anticipated. Certain tasks have an execution time that is heavily dependent on input parameters and current state. For example, in games, the number of objects presents in a scene and their complexity affects the time required to render the scene (because one has to render more or fewer polygons). Work load variations in multimedia data are a well-known phenomenon. It is sufficient to know and model the variability in the execution time of tasks. The modeling can be done either through parametric means (simple) or even at a more refined level (complex) which could lead to the evaluation of a model. For example, consider scene updates. They could be modeled as a workload of the N (dynamic value) objects present in the scene or could be specified as a complex model that takes into account game events that impact the number of objects and their update complexities. More complex models are more precise and have more potential for opportunities.

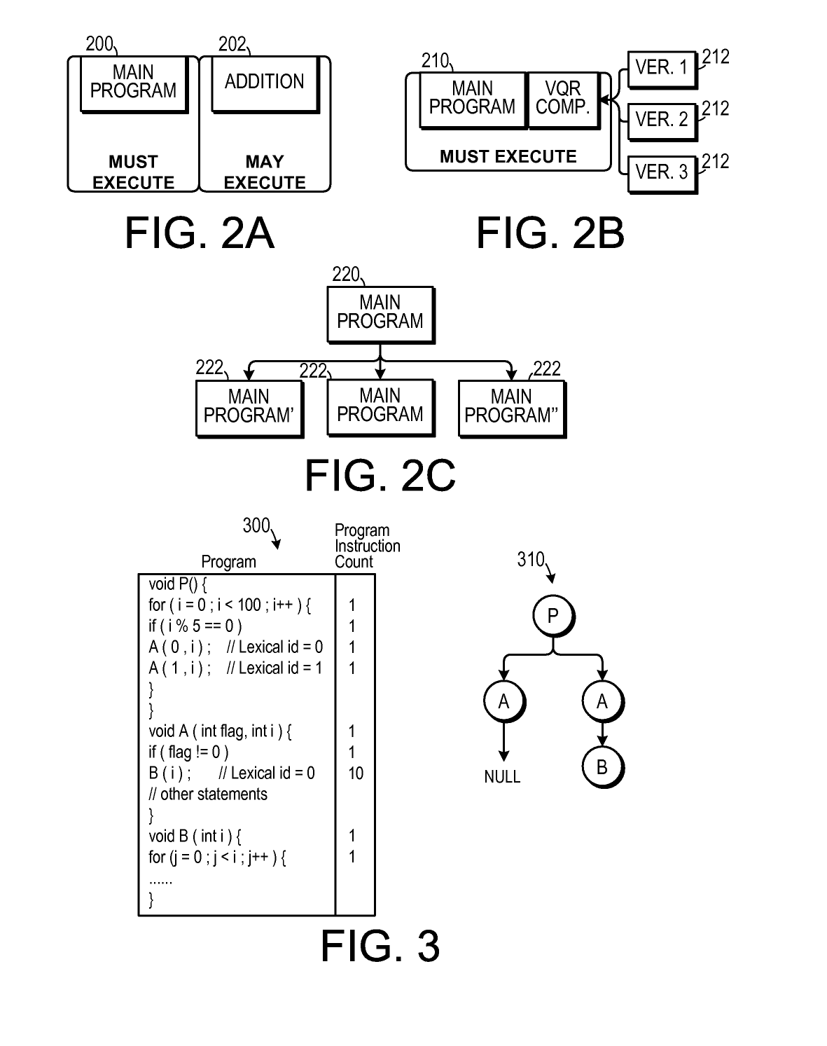

Opportunistic computing becomes all the more important when applications allow for varying quality of result. This is especially true in games where more than one result is acceptable. A program's semantics can be described by specifying several ways to do the same task. As shown in FIG. 2B, a main program 210 may call one of several different versions of code 212 to execute a task. For example, in one type of game, a “bot,” or computer controlled player, requires some artificial intelligence (AI) to function correctly. However, there are different levels of AI complexity that can give different qualities to bots. The different choices for AI form a group of which we must choose one and only one. Added complexities could involve that the choice be limited to only a few entities from the group in a given context.

An important concept in this embodiment is quality. Quality is difficult to define in a general sense as it is largely program dependent. As such, the system allows the user to define what quality is. As quality is difficult to define at a conceptual level, the system uses an operational definition. At a high level, quality is an attribute associated with an object or value. Quality values are attached to an object, and, under certain conditions, can be compared. A partial order is present on quality values and this allows the runtime and programmer to reason about which object is better. Each quality value is a vector of numbers, allowing quality to be controlled for multiple aspects of the object or value.

Quality values can be associated with program objects or values. They describe the current state of the associated object or value. For example, suppose a particle simulation system where the position of a particle is determined by the position of its neighbors and a force field (wind, gravity, etc.). In such a system we could introduce two quality parameters:

The number of neighbors taken into account to calculate the position;

A Boolean indicating if the force field was taken into account.

A particle position object would be associated with a quality value of the form (5, 0) for example. This would indicate that 5 neighbors have been taken into account to calculate the position and that no force field was used. In this embodiment, the programmer specifies the acceptable quality level for a data element. For example, the programmer could specify that at least 10 neighbors have to be taken into account and that the force field must be used. The particle position object with quality value (5, 0) does not meet these criteria and would have to be modified until its quality value is at least (10, 1).

Quality is a notion that allows the programmer to specify the state of an object or value with regards to the type and amount of processing that it has been subjected to. Quality parameters define what type of modification is being tracked by the quality value. When an object is modified, if the modification is being tracked, the quality parameter value associated with the modification should also be modified. Quality parameters can track different types of modifications. For example, accuracy level relates to the degree of accuracy required in a computation: if a program is calculating the Taylor series expansion, a quality parameter could track the number of terms that were used to calculate the expansion. Precision level determines a level of precision required. Current languages provide float and double for example to allow computations at various levels of precision. The precision of a value could also be a quality parameter and used to estimate the error on a result. One quality parameter could indicate which computation has been applied to a data element. For example, in a game, a quality parameter could be used to track which decision method was used in an AI algorithm.

In this model, each data element can be associated with a level of quality. However, this may not be enough to allow the runtime to make decisions about how to change the quality level of the data elements. Each data element thus includes procedures that can modify the quality level of the element given some input data. Each procedure includes information about: the input elements that it requires, the quality modifications that it will do, and its resource requirements. The runtime will use this information to determine how best to modify the quality of an element within the constraints of the machine (resource constraints) and the time constraints.

Throughout the execution of the main program, the programmer inserts calls to the runtime that allow him to specify one of the following:
Quality requirement: The programmer can require a specific data element to be of a requested quality at this point in the program.
Future quality requirement: The programmer can inform the framework of possible future needs of quality for a given data element. This can allow the runtime to preemptively calculate the data element at the given quality level to have it ready when it is needed.
Input argument updates: This signals an update to the input arguments used to calculate a data element. Note that all data passed to the computations is copied and not shared.
Queries: The programmer can query the runtime as to the current state of calculations, the availability of results for data elements, etc. This information can be used by the programmer to check how the runtime is handling the work that is being given to it. It can help the programmer to better direct the runtime.

The check-points will thus inform the runtime as to the requirements of the programmer. The runtime will then decide how best to meet the programmer's needs. To do so, it will launch tasks in parallel threads to perform calculation to modify the quality of data elements. The runtime also takes care of all synchronization issues between the main thread and the task threads that it launches.

The model described above for single-threaded applications is extensible to a multi-threaded application. This model does not presuppose anything on the nature of the threading. Since the data elements with quality information are regular objects and can be accessed like normal variables, it does not impose additional sharing rules on the data. Each thread can independently request a certain quality level for a data element. In its implementation, the approach will diminish the amount of redundant calculations between threads. For example, if thread A requires a quality level for data element x and, later, thread B requires the same quality level for data element x, and if thread A's calculation completed, the result is directly available for B. If it did not complete but is in progress, the runtime will not launch another computation to produce a result for B but will instead let the current calculation finish before sending back that result to B. It will also allow reusing the results of a higher quality computation towards fulfilling the request for a lower quality computation request (it may be noted that, in this approach, there may be requests of the type, “give me a result with a minimum quality of X” and thus, higher quality results always satisfy such requests).

In this model, a “main thread” instructs the runtime of certain quality requirements. The computations launched by the runtime as a result of these instructions operate in a closed environment where all data is copied over to them (there is no sharing of data to prevent synchronization issues). Thus, each computation thread can also be viewed as a “main thread” operating in a new environment. Thus the model can be extended to have hierarchical computation launches. A computation can thus also interact with the runtime to request quality requirements for some of its elements. However, computation threads have one additional feature that the main “main thread” does not have: when a quality requirement is given to the runtime, the runtime will check if the data has been made available to the computation thread by its parent through an input argument update. Input argument updates serve as synchronization points to some extent of the input data given to the computation thread. Since none of the data is shared, without these synchronization points, the computation thread can evolve with a totally different value for some of its input elements than the parent thread. Although this may seem counter-intuitive at first, it is in line with the requirement of prohibiting data sharing. To summarize, computations threads are hierarchical. Level zero corresponds to the main threads (the one that the programmer explicitly launches) and higher levels correspond to computations launched by the runtime. Each computation thread can in turn launch other computation threads.

Thus, this model introduces a new program flow view where the flow is determined dynamically at runtime by the above-described framework. Main threads instruct the runtime as to what they require in terms of quality of data elements and the runtime will dynamically launch the best possible computation thread to satisfy the main threads or reuse the results of higher quality if already available. The computation threads, which operate in a totally new environment, can also, in turn, interact with the runtime to request a certain quality from their data elements.

The model described above would not be opportunistic if the quality requirements given by the programmer to the runtime were strict requirements. Opportunity arises when the programmer can specify a wish for better quality but let the runtime decide whether or not it is possible to satisfy that wish. Thus, in one embodiment, there are three types of quality requirement directives: a) strict requirement, b) preference requirement, c)trade-off requirement.

The strict requirement is the most straightforward of all. It allows the programmer to specify that the main thread should block until a result of at least the given quality is obtained. With a strict requirement, the programmer wants the most control over the execution of the program and will force the runtime to make decisions that it may not have made under a less constrained request. Note that computation threads cannot make a strict requirement as this could lead to deadlock situations. Only the main threads can make such requests.

The preference requirement reflects the programmer's wish to obtain a result of at least a given quality. Note that in our current implementation, all quality values in the quality vector are considered independent and as such, vector [q₁] is considered a better quality vector than vector [q₂] if all elements of vector [q₁] are higher than the corresponding elements of vector [q₂]. The programmer thus specifies a wish but the runtime will immediately return the best value that it can at that time. In other words, this requirement is just a wish and may not be fulfilled. It does not, however, incur any wait time for a better result.

The trade-off requirement allows the programmer to specify a desired quality level and a maximum wait time. The runtime will try to return the specified quality or better within the given timeframe. If it cannot, it will fall back on preference requirement. This requirement gives the runtime the most leeway in deciding what computations to launch and is the best to make the program the most opportunistic possible.

For a program to use this infrastructure, two steps are required. In a first phase, the programmer must inform the runtime of all the possibilities that it has to improve quality for a given class of objects. The programmer must also define the quality parameters that will be relevant to him and inform the runtime of them. This is the registration phase. In a second phase, the programmer will make use of the runtime by informing it of its quality requests as described in below.

During the registration phase, the programmer must specify processor objects and register them with DataWithQuality objects. DataWithQuality objects are also registered with the runtime to enable the runtime to identify them uniquely.

A processor may be defined in as follows:

```
template<class BaseType , class InputType>
class Processor {
  /* ... * /
  Processor(void (func) (BaseType * curValue ,
    QualityVector * curQuality , const U
    serInput<BaseType, InputType> * input));
} ;
```

A processor is a combination of three functions:
A work function as defined above. The work function will take a current value for an object, its current quality and other input data and produce the same object at a different quality level.
A quality modification function which estimates how the processor is going to modify an data object in terms of its quality.
A cost estimator function which estimates the cost of the processor.

All three functions have to be defined by the programmer. It may seem difficult for the programmer to write the latter two functions, but they are merely used as indicators by the runtime. They help it determine the best processor to use to meet the quality requirements while still meeting soft deadlines.

At the start of the program, the programmer must specify all the Processor objects and register them with the appropriate DataWithQuality objects.

A DataWithQuality object wraps around an arbitrary user-defined object and adds a notion of quality to it. A DataWithQuality instance will contain multiple values for the wrapped object, all with different levels of quality. A DataWithQuality object may be defined as follows (only important methods are shown):

```
template<class BaseType , class InputType>
class DataWithQuality {
  DataWithQuality(BaseType * toWrap);
  static ProcessorId
    setProcessor(Processor<BaseType ,
    InputType>* processor);
  ProcessorId
    setLocalProcessor(Processor<BaseType ,
    InputType>* processor);
/* ...* /
static void addQualityType(QualityType type);
/* Similarly , instances can have their own quality
types * /
protected:
  std :: vector<DataQualityPair<BaseType>> values;
  DataWithQualityId instanceId;
  BaseType*
    getResultForQuality(QualityVector * quality);
  BaseType*
    getBestResultForQuality(QualityVector * quality);
  BaseType*
    getBestPossible(QualityVector * quality);
  /* ...* /
};
```

A DataWithQuality class (note that because of the use of templates, there is a different class for each different type of wrapped object) thus contains Processor objects that the programmer must set to indicate what operations can execute on a particular object. This may also be set at an instance level. It also contains a set of values (contained in values) that correspond to all the different values, at varying degrees of quality, that have been calculated for the wrapped object. The runtime is made aware of the DataWithQuality object through the instance Id of the class. Each DataWithQuality class also has a set of QualityType that it cares about. The composition of all the QualityType form the QualityParameters described above.

This defines what quality variables are important to this particular class and that will be modified by the Processor objects operating on these objects.

DataWithQualityVariable objects: The above-described DataWithQuality object is a backing object that encapsulates all information regarding an object associated with a quality in our framework. However, it cannot be treated like a normal variable as such because it is shared across multiple threads. In particular, the threads launched by the Processor objects will access the DataWithQuality objects through the runtime to update values and store their new-found results. Multiple programmer-created threads can also share a DataWithQuality object. To solve this data sharing problem without resorting to complex locking mechanisms (something we wanted to do away with in our framework), we introduce the DataWithQualityVariable object which is defined as follows:

```
template<class BaseType ,
class InputType> class DataWithQualityVariable {
  DataWithQualityVariable(DataWithQuality<BaseType ,
    InputType> * dataBacker);
  /* ...* /
  BaseType& getValue( ) const ;
  QualityVector get Quality( ) const ;
  protected:
    BaseType * currentValue;
    unsigned int indexInValues;
    std :: vector<UserInput<BaseType ,
        InputType>> instanceUserInput;
};
```

DataWithQualityVariable can thus be viewed as an instance of a DataWithQuality object. It contains a private copy of a particular value and quality which can be used by a thread safely. It also contains all data that is to be used to calculate new values for the wrapped object. Obviously, DataWithQualityVariable objects are not meant to be shared. All quality request operations are made on a DataWithQualityVariable object.

Once the registration phase is over, the runtime has all the information it needs to manage quality.

The runtime API may be kept simple. One embodiment employs the smallest number of directives that would allow the greatest expressibility. The query functions are given to give feedback to the programmer but have no fundamental influence. Input setting functions merely delegate to one of the DataWithQualityVariable object. The important functions are described as follows:

```
class Runtime {
  template<class BaseType , class InputType>
  void requireQuality(
    DataWithQualityVariable<BaseType ,
    InputType> * variable , QualityVector
    * reqQuality);
  template<class BaseType , class InputType>
  void preferQuality(
    DataWithQualityVariable<BaseType ,
    InputType> * variable , QualityVector
    * prefQuality);
  template<class BaseType , class InputType>
  void tradeoffQuality(
    DataWithQualityVariable<BaseType ,
    InputType> * variable , QualityVector
    * reqQuality , unsigned int waitTime);
  template<class BaseType , class InputType>
  void futureQuality( const
    DataWithQualityVariable<BaseType ,
    InputType> * variable , QualityVector
    reqQuality , unsigned int availTime =0);
} ;
```

The calls closely match the different quality requirements that a programmer can send described above. Each call takes a DataWithQualityVariable object that will be modified (except in the case of a future quality request) to contain the new value as computed by the Processor objects associated with type passed. All calls (except the future quality request) are blocking although some may block for longer than others. The requireQuality call will block until a result of sufficient quality has been calculated. Other calls will block for much less time(the preferQuality call will block for a very short while as it only returns values that are currently available).

An important concept behind opportunistic computing is extensible program semantics. The runtime's role is to provide the programmer with the possibility of adding, improving or morphing computations that are taking place. The simple API we provided and described above allows the programmer to express those variability in semantics. Three possibilities for extending a program's semantics include: addition, extension and morphing.

Addition may be the most straightforward concept, as shown in FIG. 2A. The programmer defines an optional computation 202 to be computed in addition to a main computation 200. The optional computation 202 has no required effect. In a game for example, additional effects can improve the visual rendering, can make models more realistic (to resemble the human body more closely, for example). Additional effects can have a high impact on the “coolness” factor in a game and are thus important to game programmers. Unfortunately, they have to cut some of them out of game releases as they can be very resource consuming. With this embodiment, programmers can leave these effects and they will run only if resources are available in sufficient quantities.

Refinement means that a processor can use a previously calculated result by another processor and bypass some of its computations. For example, in a program calculating Taylor expansion terms, if processor A has calculated the first 10 terms of the expansion, if processor B wants to calculate 20 terms of the expansion, it should not have to recalculate the first 10 terms. Our runtime allows support for this.

Previous concepts added small pieces of computation locally without significantly changing the overall flow of the program. As illustrated in FIG. 2C, in the scenario of program morphing, the system allows a program 220 to morph into a more resource intensive program 222 performing a similar task. For example, in the MPEG encoding algorithm, a task that started out coding an I frame could morph into coding a P or B frame provided enough time and resources are available. The morphing will require more resources for a longer period of time and thus, mispredicting a program morphing can be expensive. However, it does allow interesting programming possibilities especially in soft real-time systems since deadlines are not hard.

When the runtime receives a quality request from a thread in the program it will try to satisfy it as quickly as possible. The basic algorithm is given in the following algorithm (the algorithm changes slightly depending on the type of request the runtime receives):

```
Input:DataWithQualityVariable data
Input:QualityVectorreqQuality
Output:DataWithQualityVariableresultData
Output:QualityVectorretQuality
if ∃value st. Quality (value) > reqQuality then
  return value and Quality (value)
else
  if ∃ running Processor p st.
    Quality (Result (p)) > reqQuality then
      Wait for p;
      return Result (p) and Quality (Result (p))
    else
      foreachProcessor p applicable to data do
        if QualityResultEstimate (p) >
        reqQuality then
          if
          CostEstimate (p) < availResource
          then
            foundP rocessor = p;
            break
          end
    end
  end
    if foundP rocessor then
      Launch foundP rocessor;
      Wait forfoundP rocessor;
      return Result (foundP rocessor) and
      Quality (Result (foundP rocessor))
    else
        FindBestMatch;
    end
  end
end
```

For a strict quality requirement, the full algorithm will be used. For a prefer quality requirement, only results currently available will be used. For a trade-off quality requirement, the runtime will use the full algorithm but will abort it if it goes over the time given to it by the programmer. For a future quality requirement, the full algorithm will be used but nothing will be returned.

The runtime tries to schedule as many computations as possible while meeting as many of the soft real-time constraints imposed on it. Certain quality requests are more critical than others. For example, a strict quality requirement is more important than a future quality requirement as the strict quality requirement is blocking whereas the other is not. As such, computations may be assigned priorities as follows: (1) Computations resulting from strict quality requirements are given the highest priority; (2) Computations stemming from trade-off quality requirements are given a priority based on the amount of time the program is waiting to wait. A shorter wait time will result in a higher priority; (3) Computations derived from future quality requirements are given a lower priority; and (4) All other computations that may have been launched because of a great availability of resources are given the lowest priority.

The runtime is responsible for assigning priorities to the various computations that it launches. The OS will then be responsible for scheduling the various tasks. However, to exercise more control on the active computations, the runtime can also abort computations that may be doing too much (for example, future quality requirements) if it sees that it will have trouble meeting deadlines.

The runtime enables the programmer to express extensible semantics. Addition of an additional computation is very easily done with the runtime. The code for adding a computation is given as follows:

```
QualityVector qv = (1); /* Corresponds to
  additional task being done * /
globalRuntime->futureQuality(data,&qv, time);
/* Do some work for time * /
globalRuntime->tradeoffQuality(data , &qv,
  waitTime);
```

In the code snippet above, the system considers one QualityType which can take either a value of 0 or 1 depending on whether the additional computation has been performed. The programmer starts by informing the runtime that he will want the additional task run on the data (by specifying that the quality should be 1). Some parallel main task is then performed. The tradeoff Quality call asks the runtime to return the result of the computation. If the additional task has completed, the result will be returned immediately. Otherwise, the runtime has the option of waiting for waitTime. If after that time, the result is still not available, data will be returned unmodified (with a quality of (0)).

Revision is a complex concept for the programmer to implement but can be very powerful. One example is based on the MPEG algorithm. In the MPEG algorithm, pictures (or frames) can be encoded as I-frames, P-frames or B-frames. The I-frame is easy to encode, but uses the most space. P and B-frames allow temporal compression (by comparing the frame to past and possibly future frames), but require additional work to find the “motion vector” that identifies how the image has changed. Calculating the motion vector is an expensive process and exhibits a great variation in execution time (the algorithm might find the motion vector right away or it might have to search the entire space). The runtime is made aware of the motion changes and will make the new input available to the processor launched when futureQuality was called. The processor is then responsible for checking whether new inputs are available. While this puts the burden on the programmer, it also allows great generality and flexibility. The processor can ignore any input change or partially take them into consideration.

Refinement is a concept completely implemented by the runtime. One example includes calculating Taylor expansion terms. If a programmer-defined thread A requires an object foo to be of quality 10 (with 10 terms used) and a programmer-defined thread B requires the same object to be of quality 20, originally, both threads have foo of quality 0. When thread A makes a call to the runtime, a processor to calculate the first 10 terms is launched. When thread B makes a call to the runtime, the runtime will notice that the first 10 terms are being calculated by another Processor. It will then look for a Processor capable of bringing the quality from 10 to 20 and compare it with a Processor capable of bringing the quality from 0 to 20. In this case, it will most likely determine that it is better to wait for the result from the Processor already running and pipe it to another processor to meet B's request.

This does require some support from the Processor objects and they have to be written to be extensible. In one example three processors may actually be one and the same with intelligent quality estimator and cost estimator functions. The runtime will present all the possible values that it has access to (current and in progress) as base input to the estimator functions of all the processors. This allows the processors to determine the estimated produced quality and cost based on the quality of the value that it will be passed in.

Morphing is intrinsically supported by the runtime as it chooses a processor to improve quality based on quality requirements, but also resource constraints. The computations launched by the runtime to meet the quality requirements can thus be radically different depending on resource availability. This concept, as applied to the coding of an MPEG frame is illustrated as follows:

```
QualityVector qv = (1); /* Signifies produce
  at least an I-Frame * /
globalRuntime->tradeoffQuality(frameData ,
  &qv, availTime);
```

Supposing the programmer defines three processor objects, one calculating an I-frame, another a B-frame and a third a P-frame, the runtime can dynamically choose which one to run based on the resource availabilities and the time constraint given by the programmer. Here, the main program, which will be blocked until one of the processors finishes calculating, will take on one of three possibilities.

A large class of applications fall under the category of soft real-time, including end-user applications like gaming and streaming multimedia (video encoders/decoders, for example). Such applications tend not to be mission-critical like hard real-time applications that require absolute guarantees that their execution deadlines will be met. With hard real-time applications, guarantees on meeting deadlines can be made by following very conservative design principles with provable properties, or by having a runtime system that conservatively schedules the component tasks of the application to ensure that certain real-time guarantees are met. In contrast, soft real-time applications do not require absolute guarantees that their real-time constraints will always be satisfied. In most soft real-time applications, if the deadlines are met most of the time, it is quite adequate. This relaxation of guarantees allows a soft real-time application to aggressively perform more sophisticated computation and maximally utilize the available compute resources. Such an aggressive approach makes it difficult to analyze for and prove hard guarantees on real-time constraints, and is therefore ill-suited for hard real-time applications. For example, games, streaming live-video encoders, and video players attempt to maintain a reasonably high frame-rate for a smooth user-experience. However, they frequently drop the frame rate by a small amount and occasionally by a large amount if the computation requirements suddenly peak or compute resources get taken away. This is acceptable in soft real-time applications.

There is a large body of formal design and analysis techniques that determine the worst-case execution-time characteristics of different tasks in a hard real-time system and use these to either prove the satisfaction of real-time constraints or to develop scheduling strategies for achieving the same. However, soft real-time applications can use such a very wide variety of relaxed guarantees that so far no sufficiently broad formal framework exists for the analysis and design of these applications.

One embodiment employs a Statistical Analyzer tool that detects patterns of behavior and generates prediction patterns and statistical guarantees for those. The patterns of behavior consist of segments of function call-chains, annotated with the statistics predicted for them. The call-chains are further refined into minimal distinguishing call-chain sequences that unambiguously detect the corresponding pattern of behavior when it starts to occur at runtime, and make statistical predictions about the nature of the behavior. Furthermore, the Statistical Analyzer is able to generate call-chain patterns that can reliably predict the occurrence and execution-time statistics of future patterns based on the current occurrence of a pattern. Lastly, the programmer can interactively direct the Statistical Analyzer to look for specific types of application-specific correlated behavior.

The embodiment employs a Context Execution Tree (CET) representation of the profile information, and various analysis techniques that can identify, characterize, predict and provide guarantees on behavior pattern based on the CET. In a CET representation for capturing the dynamic context of execution of function-calls in a program employs a plurality of nodes. Nodes in the CET represent function invocations (calls) during the execution of the program. The root node represents the invocation of the main function of C program. For a given node, the path to it from the root node captures the sequence of parent function calls present of the program call-stack when the function corresponding to the node was called. Multiple invocations of a function with the same call stack will all be represented by a single node. However, multiple invocations of the same function with different call stacks will result in multiple nodes for the same function, with the path from root to each node capturing the corresponding call stacks.

A simple CET 310 corresponding to a brief section of code 300 is show in FIG. 3. The CET can be constructed from a profile of program execution. The profile consists of a sequence of function-entry and function-exit events in the order of their occurrence during the execution of the program. The CET can be formally defined in terms of its structural properties and the annotations on each node. The structure of the CET representation captures the following information about the execution profile of a program: (1) The path from root to each node uniquely captures the call stack when the function-call represented by the given node was executed. The path is unique in the sense that all invocations of the function under the same call stack will be represented by a single CET node. (2) For every node in the CET, the corresponding function call was invoked at least once, under the call stack represented by the path from root to the node. That is, the structure of the CET captures only those call stacks that actually occur during the profile execution of the program. (3) The children nodes of a given parent node are listed in an ordered sequence from left-to-right. They are in the lexical order of occurrence of the corresponding call-sites of the children function-calls in the body of the corresponding parent function. That is, the lexically first function-call within the body of the parent function becomes the left-most child of the corresponding parent node, while the lexically last function-call becomes the right-most child. Children function calls that are never invoked in the call stack of the parent node do not get a CET node. Instead a NULL edge serves as a lexical placeholder.

In the CET 310 show in FIG. 3, Function A was invoked from two call-sites within the parent function P. This leads to two children nodes for function A. Since function B was never invoked in the left B node, it only gets a NULL edge under the A node at the lexical position of its call-site in the body of function A. Note that all function call-sites within a parent function can be put in a single lexically-ordered sequence despite the presence of control flow constructs like loops, goto statements, if-then-else blocks or case statements. Each node is annotated with the following pieces of information about the execution of the function-call corresponding to it: (1) invocation count N: The number of times the corresponding function-call was invoked. (2) mean: The mean execution time across all invocations of the function-call corresponding to the node. This includes the execution time of all children function calls. (3) variance: The statistical variance in the execution time of the function-call across all invocations. Variance is the square of the standard deviation. (4) co-variance matrix C: This correlates the execution time of all the children function-calls and the execution time spent purely in the current node (i.e., not counting the time spent in children). If the node has F children, then C is an (F+1)×(F+1) matrix.

In order to relate the observed behavior of the program with the call-chains active at the time we need to generate a trace of all function-call entry and exit points encountered during program execution, along with the execution-time expended between successive such points. Furthermore, in our framework the specific call-site of a function-call within its parent function is also significant. Therefore, each function call within its parent is uniquely identified by the lexical position of its call-site in the body of the parent. The lexical position is termed the lexical-id of that function-call. The application profile consists of a sequence of profile events. There are two types of profile events: (1) function-called lexical-id entry dyn-instr-count; and (2) function-called lexical-id exit dyn-instr-count.

The first type signals entry of program execution into a function, the second exit from a function. A function called “function-called” has been entered or exited at the time this profile event was generated. The profile event dyn-instr-count gives the dynamic instruction count since the start of the program at the point the profile event was generated.

The Statistical Analyzer reads the sequence of profile events. At any entry event in the profile, the Statistical Analyzer knows which parent function invoked the current function call. This would simply be the last entry event prior to the current one for which no corresponding exit event has yet been encountered.

The Statistical Analyzer constructs the CET (the tree structure) in a single pass over the profile sequence. It makes a second pass to calculate the variance and co-variance node annotations. The following is a description of these passes.

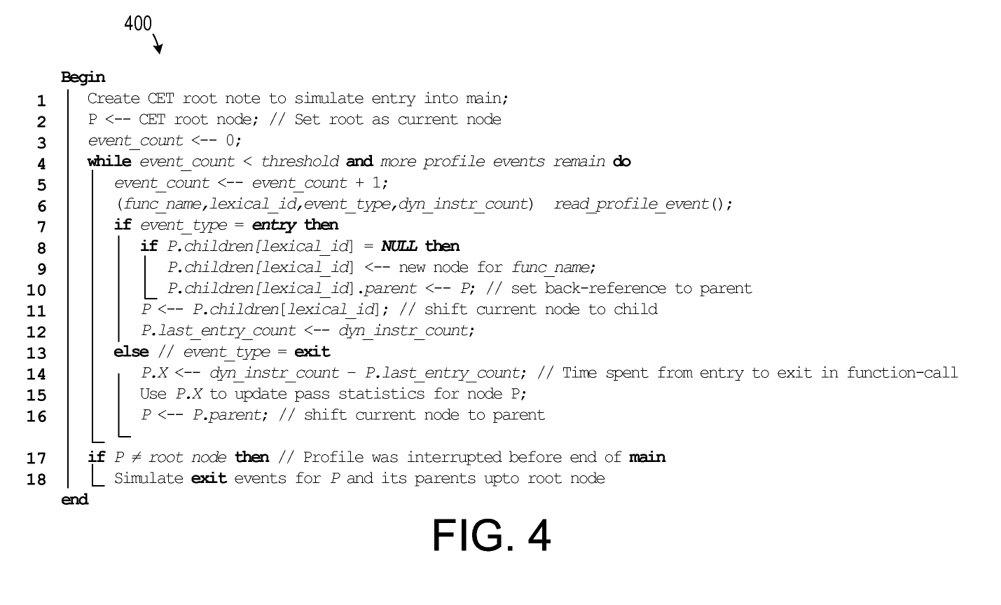

As shown in FIG. 4, an algorithm 400 may be used to constructs the CET by making a single pass over the profile data. The algorithm starts by creating a single node to represent the main function, which will contain the rest of the program profile as children nodes. The algorithm maintains a current node in the P variable. The current node is the last function-call that was entered but has not yet exited. Therefore, an entry profile event represents a child function-call within the current node. An exit profile event causes the current node to be shifted to its parent. When the exit event is processed for the current node, the total execution time spent within the current invocation of the function-call (including inside all of its children function-calls) is calculated in the P.X variable in step 14 of the algorithm. In the first profile pass, a P.total_count variable is updated in step 15 of the algorithm as follows: P.total_total−P.total_count+P.X to keep a running sum of the total execution time spent in node P so far in the execution of the program. The P.N variable keeps track of the total number of times P has been entered so far. At the end of the first profile pass, the mean execution time inside each CET node can be calculated as P.X=P.total_count divided by P.N.

A second profile pass uses the algorithm 400 shown in FIG. 4 to make a fresh pass over the same sequence of profile events. All the CET nodes already exist and no new nodes are created. The mean execution time for each node P is available in P. In Profile Pass 2, step 15 calculates variance by maintaining a sum-of-squared-errors which is updated as follows at each exit event for a node P, where P.X is the execution time spent in the current invocation of the function-call represented by node P. P.X is calculated in step 14 of the algorithm. At the end of Profile Pass 2 the variance is calculated for every node P. To calculate the co-variance matrix, the execution time spent in each child node of P during the current invocation of P is maintained as well.

Once the CET has been constructed and its node annotations calculated, the CET is traversed in pre-order to determine nodes which exhibit interesting behavior as evidenced by their node annotations. Nodes whose total execution time constitutes a miniscule fraction (say, <0.02%) of the total execution time of the program and their children sub-trees, are deemed as insignificant. All other nodes are deemed significant. Since CET nodes subsume the execution time of their children nodes, once a node is found to be insignificant, the nodes in its children sub-tree are guaranteed to be insignificant as well.

Since insignificant nodes individually constitute a miniscule portion of the program's execution time, any patterns of behavior detected for them would quite likely provide very limited benefits in optimizing the design of the whole application. Therefore insignificant nodes are ignored from all further analysis. This dramatically reduces the part of the CET that needs to be examined by any subsequent analysis looking for interesting behaviors, leading to considerable savings in analysis time.

The process examines annotations of nodes to determine if the corresponding nodes exhibit one or more of the following types of behavior: (1) The variance is low; (2) The variance is high; or (3) cross-covariance exposer: The co-variance matrix contains terms that are large in absolute magnitude. In the preceding, low, high and large are established based on relative comparisons. Once the CET is constructed from the profile data, it is traversed in pre-order and individual nodes may be tagged as being low-variant, high-variant or exposer-of-cross-covariance. As mentioned earlier, the traversal is restricted to significant nodes.

The next step is to find patterns of call-chains whose presence on the call-stack can be used to predict the occurrence of the interesting behavior found at the tagged nodes. For a given tagged node P, the system restricts the call-chain pattern to be some contiguous segment of the call-chain that starts at main (the CET root node) and ends at the tagged node. The system also requires the call-chain pattern to end at the tagged node.

The names of the sequence of function-calls in the call chain segment become the detection pattern arising from the tagged node. This particular detection pattern might occur at other places in the significant part of the CET. Quite possibly, the occurrence of this detection pattern elsewhere in the CET does not lead to the same interesting statistical behavior that was observed at the tagged node. Therefore, the criteria in generating the detection pattern is the following: All occurrences in the significant CET of a detection pattern arising from a tagged node must exhibit the same statistical behavior as the tagged node.

This condition is trivially satisfied if the detection pattern is allowed to extend all the way to main from the tagged node, since this pattern cannot occur anywhere else due to the CET's first structural property. In many applications patterns extending to main are likely to generalize very poorly to the regression execution of the application on arbitrary input data. Regression execution refers to the real-world-deployed execution of the application, as opposed to the profile execution of the application that produced the profile sequence used for constructing the CET. In many applications we expect the behavior of the function call at the top of the stack to be correlated with only the function-calls just below it in the call-stack. This short call-sequence would be expected to produce the same statistical behavior regardless of where it was called from in the program (i.e., regardless of what sits below it in the call stack). One embodiment detects such call-sequences, referred to as Minimal Distinguishing Call Sequences (MDC sequences) corresponding to any particular statistical behavior. These are the shortest length detection sequences whose occurrence predicts the behavior at the tagged node, with no false positive or false negative predictions in the CET.

Given a tagged node P, an algorithm produces the MDC sequence for P that is just long enough to distinguish the occurrence of P from the occurrence of any other significant node in P that has the same function-name as P but does not satisfy the statistics behavior of P (the other_set). This is done by starting the MDC sequence with a call-chain consisting of just P, and then adding successive parent nodes of P to the call-chain until the MDC sequence becomes different from every one of the same length call-chains originating from nodes in the other_set. Therefore, by construction, the MDC sequence cannot occur at any CET nodes that do not satisfy the statistics of P. However, the same MDC sequence may still occur at multiple nodes in the CET that do satisfy the statistics for P (at some nodes in a match_set). There is no need for P's MDC sequence to distinguish against these nodes as they all have the same statistics and correspond to the call of the same function as for P. Since all nodes in the match_set will have the same other_set, the algorithm is optimized to generate the other_set only once, and apply it for all nodes in the match_set even though only P was passed as input. The algorithm outputs the MDC sequence for each node in match_set (called the Distinguishing Context for P).

The application code can be easily modified by the programmer to incorporate the detection of specific MDC sequences that the programmer determines as being most useful to detect. Given an MDC sequence the programmer has to instrument the function-calls that occur in it. If the MDC sequence is a call-chain of length k, then let MDC[0] denote the uppermost parent function-call, and MDC [k−1] denote the function-name of the tagged node that generated this MDC sequence. Therefore, the pattern will be detected to have occurred if the MDC[k−1] function is pushed at the top of the call-stack that already contains MDC[k−2] . . . MDC[0] function-calls just below in the stack. And over multiple occurrences of this same pattern at runtime, the observed statistics are expected to match the behavior statistics of the tagged node in the CET that generated this MDC sequence.

Considering scenarios where meaningful predictions can be made about the execution time of the detected pattern, if the tagged-node had been identified as low-variant then the actual expected runtime of the MDC[k−1] function call can be predicted to be the mean that was calculated for the tagged node (P.X). There can be cases where the low-variant nature of the pattern is preserved in the regression run, but the actual mean changes due to differences in the input data provided to the program. In this case, the programmer could implement a runtime prediction scheme that calculates a running mean of the observed execution time of the MDC[k−1] function whenever the pattern occurs, and uses the running mean to predict the execution time in the next occurrence of the pattern. Things are a little more complicated when making predictions for a pattern originating from a high-variant tagged node. Since the execution time for MDC[k−1] is expected to vary according to the associated standard-deviation, it is not simple to predict the execution-time for MDC [k−1] the next time the pattern is detected to occur, even though the observed runtime standard-deviation over multiple occurrences of the pattern matches the tagged value. However, if during analysis the execution-time of the tagged-node had been found to fall into a narrow bin most of the time, then we could always predict the execution-time of MDC[k−1] as the value of that bin. Such a prediction would still be correct with a high probability. The presence of a few large outlier execution times can get a node tagged as being high-variant even though it is low-variant most of the time. For more general high-variant pattern, the binning technique can be used to construct a discrete probability-density-function (pdf) of the execution-time of the pattern. Furthermore, the execution time of multiple high-variant tagged-nodes identified by the programmer can be correlated by the Statistical Analyzer to produce a joint pdf (multivariate pdf). At runtime, the program could be instrumented to observe the execution time of one pattern (corresponding to one of the programmer identified nodes), and use the joint pdf to predict the execution time of a subsequently occurring pattern. We use Vector Quantization based clustering techniques to determine when and how to create bins and joint pdfs. Patterns for nodes tagged as cross-covariance exposer essentially undergo the same binning and joint pdf analysis. This analysis is done over sibling function-calls that have been found to be strongly correlated inside the tagged parent node. However, analysis for such patterns can be done automatically without the programmer having to identify nodes manually. Furthermore, as described for the low-variant case, the programmer can easily incorporate techniques to learn execution times at runtime, if the exact means, bin-values and standard-deviations measured during analysis do not generalize for the regression runs.

The detection of patterns at runtime does not require an active monitoring of the call-stack. In fact, given that the programmer will ultimately be interested in incorporating just a few patterns that yield the most benefit, directly instrumenting the affected function call-sites would be the easiest solution. For each pattern, the programmer would need to create a global program variable, say g, for each given MDC sequence. Just before the call-site for function MDC[i+1] inside the body of function MDC[i], the programmer can add code to increment g provided g==i, and similarly decrement g after the call-site. Finally, at the call-site of function MDC[k−1] inside the body of MDC [k−2], the check g==k−1 could be made. If the check succeeds at runtime, the pattern is just about to occur on the call-stack, and predictions about the execution-time of MDC[k−1] can be made. If the MDC sequence contains repetitions due to recursive functions, then the programmer can use standard sequence detection techniques (using Finite-State-Machines) to work out the correct methodology for detecting the occurrence of the pattern.

In the discussion above, a call-chain could only be detected at runtime whenever it occurred in full. Only when the entire call-chain pattern occurred on the call-stack, could a prediction about the execution time of the MDC[k−1] function be made. However, with additional analysis, it is possible to observe the occurrence of only a prefix of the pattern and predict with high probability that the remaining suffix of the call-chain pattern will occur (with the behavior statistics associated with the full pattern). This prefix-suffix analysis is done by examining each possible suffix of a pattern at a time. For a given suffix, the ratio of the occurrences of the full pattern in the CET against the occurrences of just the prefix serves as the prediction-probability that the suffix will occur in the future given that the prefix has occurred on the call-stack. The prediction-probabilities can be efficiently calculated for all suffix sizes if we first start with a suffix of size 1 and grow from there.

The discussion above assumes that the programmer desired to distinguish between tagged nodes if their statistics didn't match exactly. However, in the certain circumstances the statistics that match only in some respects or match approximately may be preferred over exact matches.

Exact statistics lead to very long detection patterns that generalize poorly to regression runs. For example, if multiple low-variant tagged nodes with different means require long call-chains to distinguish between them, then it may be preferable to actually have a shorter call-chain pattern that does not distinguish between the tagged nodes. The short pattern would have multiple binned means associated with it, along with a pdf of the occurrence of each mean. This would be very useful in situations where each of the originally distinguishable patterns occurs many times during regression, before the next long pattern occurs. A simple runtime scheme based on the short pattern would achieve very high prediction accuracy by using the last observed execution-time of the pattern as the prediction for its next occurrence. Similar techniques could be used to relax the combination of multiple long high-variances or cross covariance exposer patterns based on approximate comparison of one or more of variances, means and strongly correlated covariance-terms.

If the same detection sequence occurs at multiple tagged nodes in the significant CET and each of the tagged nodes have the same statistical behavior, then we would like to combine the multiple occurrences of the detection sequence into a single detection sequence. Such detection sequences are likely to generalize very well to the regression run of the application, and are therefore quite important to detect.

To address the preceding two concerns in a unified framework, the system first generates short patterns using only the broad-brush notions of low, high or covariance-exposer, without making a distinction between tagged nodes using their specific statistics (like mean, standard deviation, or which terms in C are strongly correlated). Then the system groups identical patterns (arising from different tagged nodes) and use pattern-similarity-trees (PST) to start to differentiate between them. The initial group forms the root of a PST. A Similarity-Measure (SM) function is applied on the group to see if it requires further differentiation. If the patterns in the group have widely different means, and the programmer wants this to be a differentiating factor, then the similarity check with the appropriate SM will fail (we have developed multiple SM functions to handle most common cases of differentiation; the programmer can further tweak parameters in the SM functions based on their desired optimization goals, or define their own custom SM functions).

Once the SM test fails on a group, all the patterns in the group are extended by one more parent function from their corresponding call-chains (tagged nodes are kept associated with patterns they generate). This will cause the resulting longer patterns to start to differ from each other. Again identical longer patterns are grouped together as multiple children groups under the original group. This process of tree-subdivision is continued separately for each generated group until the SM function succeeds. At this point, each of the leaf groups in the PST contains one or more identical patterns. The patterns across different leaf groups are however guaranteed to be different in some part of their prefixes. And patterns in different leaf groups may be of different lengths, even though the corresponding starting patterns in the root PST node were of the same length. All the identical patterns in the same leaf-node are collapsed into a single detection-pattern.

It is important to understand what kind of statistical guarantees can be made about profile-time metrics holding their value during regression runs. In certain cases, compile-time analysis of the looping structure of functions coupled with the structure of the significant CET allows the Statistical Analyzer to make very strong assertions about the generality of metrics measured during profiling. Specifically, compile-time analysis of a function establishes whether a function contains loops, or loops with an iteration count upper-bounded by a constant. If a function lacks loops or only has loops with constant-bounded loop-counts, then the body of the function cannot consume an arbitrarily large execution time. In fact, if the body of the function has simple if-then-else control-flow then its execution-time can be neatly binned and these bins generalize well to regression. In this sense, the function execution-time can be guaranteed to be bounded and possibly binnable. The only unaccounted factor is that of children function-calls. Given the structure of the significant CET, the children function-calls occurring under a detection pattern can in turn be recursively tested for boundedness and binnability. Insignificant children nodes can be ignored from this analysis if a statistical guarantee of boundedness is sufficient for the given pattern. If boundedness is established for a pattern, then the profile-time observed metrics and bins generalize very well to regression.

With the advent of multicores, there is an urgent need for parallel programming models that offer solutions that can scale in performance with the growing number of cores while maintaining ease-of-programming. In particular, Software Transactional Memories (STMs) have been proposed in order to make parallel programs easier to develop and verify compared to conventional lock-based programming techniques. However, conventional STMs do not scale in performance to a large number of concurrent threads. While the atomicity semantics of traditional STMs greatly simplify the correct sharing of data between threads, these same atomicity semantics incur a large penalty in program execution time.

Traditional abstractions used for thread synchronization such as locks suffer from a lack of scalability. It becomes increasingly hard to verify the correctness of a program as the number of threads increases, and coarse grained locking has the effect of serializing frequently accessed data. STMs deal with the increased complexity of data synchronization and consistency. With STM, “transactions” consist of programmer specified code-regions or function-invocations that appear to execute atomically with respect to other transactions. In practice, implementations of STM allow transactions from different threads to execute concurrently. STMs perform checks to determine if there is any overlap between the data accessed, and potentially modified by concurrently executing transactions. When an overlap is detected, different STM implementations selectively stall, abort and re-execute certain transactions, so as to maintain the appearance of atomic execution for each of the transactions involved. The effects of the execution of the statements in a transaction are all only visible at the end of the transaction when it is made permanent, or “committed” to global state. Thus the state modified by a STM transaction has the semantics of being updated all at once as a single unit. At the same time, STM reduces the impact on performance by allowing multiple transactions to execute concurrently under the optimistic assumption that the data read and written across the concurrent transactions will not overlap. This typically allows for much higher performance compared to serializing the transactions so that only one transaction can proceed and commit at a time. STMs detect overlap of data accesses between transactions by maintaining read-sets and write-sets for data accessed by each executing transaction. Version numbers are also maintained for data in these sets to keep track of which versions of the data are being accessed by different transactions, and therefore which transactions must be stalled, aborted and re-executed, or allowed to commit in order to maintain the appearance of atomic reads and updates for all the data accessed by a transaction. STMs provide the programmer with a higher-level data synchronization abstraction than the use of locking mechanisms, thus enabling him or her to focus on where and what atomicity is needed rather than on how atomicity is implemented. STM is a software version of Hardware Transactional Memories (HTM). HTMs are limited in the size and layout of data that can be updated as an atomic unit. This is because ownership information must be kept in hardware for every piece of memory accessed from within executing transactions. However, STMs proposed so far reason only about the consistency of data and do not provide a semantic meaning of their use. In particular, current STMs do not allow a programmer to reason about different consistency requirements of the underlying threads. In many applications (such as gaming and multimedia), the consistency semantics of threads that use STMs is very important and can be used to optimize transaction behavior.

Games are very good candidates for using STM. Large amount of shared state-threads spend a significant portion of their execution time inside critical sections. Having a lot of shared state implies that a standard STM will suffer from large number of roll-backs. High performance (frame-rates, number of game objects) and providing a smooth user perception is absolutely critical. Current STM implementations are known to suffer from large performance overheads. There are large existing C/C++ game code-bases that use lock-programming. These code-bases are proving hard to scale to quad-core architectures. The actual fidelity to real-world physics is not important so long as the user-experience is smooth and appears realistic. Therefore, not all computation has to be completely accurate. Game applications are the biggest application domain till now to make use of multicores. A high-performance parallel programming model that maintains ease of use(verification, productivity) while scaling well with the number of cores, would be highly desirable.

There are a set of movable objects (players, weapons, vehicles, projectiles, particles, arbitrary objects etc). Each of these game objects is represented by a program object that has among others, three mutable fields representing x,y,z positions of the object at an instant. The game object can be subject to many factors that change its position-game-play factors like user input, movement due to being in contact with other bodies (a vehicle for example), physical factors like wind, gravity, collision with a projectile and so on. The program object representing this game object is shared among all the modules implementing those factors. This program object (or at least the fields in that object) is thus potentially touched by a very large number of writers. It is also accessed by a large number of readers. For example, the rendering engine reads the position fields in order to perform the visibility test and to draw the object into the graphics frame-buffer. Other readers of these fields could include physics modules that perform collision detection, and game play modules that trigger events based on the players proximity. The following observations hold for the described game scenario: (1) The position fields need not be accurate on every frame. Many times, stale values will suffice. Regular STMs do not take advantage of this. All readers do not need the most up-to-date values to execute correctly. For example, reading accurate position values in collision detection may be more important than in triggering events like special effects. RSTM group consistency semantics allow optimizing for this scenario where deemed desirable and safe by the programmer. (2) The modifications made by all writers are not equally important—some modifications can be safely ignored. For example, minor modifications to a moving particle's position due to wind or gravity can be safely ignored from frame to frame. RSTM incorporates this by allowing a prioritization of writes to specific variables between concurrent transactions.

While games fit the programming model well, they also impose certain constraints on the implementation of the STM. The most important constraint is that games are written in C/C++ because of the low-level tweaking that this language allows. This imposes that our STM implementation works in C/C++. The most important consequence of this constraint is that atomicity book-keeping cannot be done at an object level as pointers allow access to virtually any point in memory. An object could be modified without going through an identifiable language construct. We thus propose a solution with a byte-level book-keeping with optimizations to limit the amount of book-keeping required.

The relaxed consistency STM model (RSTM) extends the basic atomicity semantics of STM. The extended semantics allow the programmer to i) specify more precise constraints in order to reduce unnecessary conflicts between concurrent transactions, and ii) allow concurrent transactions that take a long time to complete to better coordinate their execution. This allows the semantics of a regular STM to be weakened in a precise manner by the programmer using additional knowledge (where available) about which other transactions may access specific shared variables, and about the program semantics of specific shared variables. The atomicity semantics of regular STM apply to all transactions and shared data about which the programmer cannot make suitable assertions.

Conflict Reduction between Concurrent Transactions: Problem Conflict-sets can be large in regular STMs, leading to excessive rollbacks in concurrent transactions. This problem scales poorly with increasing numbers of concurrent threads.

Game Programmers approximate the simulation of the game world. They are very willing to trade-off the sequential consistency of updates to shared data in order to gain performance, but only to a controlled degree and only under specific execution scenarios. The execution scenarios typically depend on which specific types of transactions are interacting, and what shared data they are accessing.

Using one embodiment, programmers can assign labels to transactions, and identify groups of shared variables in a transaction to which relaxed semantics should be applied. The relaxed semantics for a group of variables are defined in terms of how other transactions (identified with labels) are allowed to have accessed/modified them before the current transaction reaches commit point. Without the relaxed semantics such accesses/modifications by other transactions would have caused the current transaction to fail to commit and retry. Fewer retried transactions implies correspondingly reduced stalling in concurrent threads.

Coordinating Execution among Long-Running Concurrent Transactions: Conflicts between long running transactions can be reduced by the previous mechanism. However, in game programming, threads often work collaboratively and can benefit from adjusting their execution based on the execution status of certain other transactions. Traditional STM semantics do not allow any visibility inside a currently executing transaction. This is because an STM transaction has the semantics of executing “all-at-once” at its commit point. In practice, this can cause concurrent threads in games to perform redundant computations if they contain many long running transactions.

Any solution to this problem cannot compromise the “all-at-once” execution semantics of transactions, without also compromising the ease-of-programming and verification benefits provided by transactions. However, even a hint saying that another transaction has made at-least so much progress can be quite useful for a given transaction to adjust its execution. This adjustment is purely speculative, since there is no guarantee that the other transaction will commit. Subsequently, the thread running the current transaction may have to execute recovery code (such as perform a computation that had been speculatively skipped by the current transaction because the other transaction had already done that computation, but could not commit it).

In domains like gaming, speculative optimizations that are correct with high probability are quite valuable for obtaining high game performance. The communication of such progress hints to other threads can be made best effort, making their communication very low overhead and non-stalling for both the monitored and monitoring transactions.

One embodiment uses Progress Indicators, with which the programmer can mark lexical program points whose execution progress may be useful to other transactions. Every time control-flow passes a Progress Indicator point, a progress counter associated with that point is incremented. The increments to progress indicators are periodically pushed out globally to make them visible to other transactions that may be monitoring them. However, the RSTM semantics make no guarantees on the timeliness with which each increment will be made visible to monitoring transactions. Each monitoring transaction may have a value for a progress indicator that is significantly smaller (i.e., older) than the most current value of that progress indicator in the thread being monitored. Consequently, the monitoring transactions can only ascertain that at-least so much progress (quantified in a program specific manner by the value of the progress indicator) has been made. The monitoring transactions may not be able to ascertain exactly how far a long in execution the monitored transaction currently is.

The RSTM language employs the constructs of Group Consistency and Progress Indicator. Use of the Group Consistency constructs reduces the commit conflicts between concurrent transactions. The Progress Indicator constructs allow for a coordinated execution between concurrent long-running transactions in order to reduce redundant computation across concurrently running transactions. These constructs are described in the following subsections.

Group consistency semantics can be specified by grouping certain shared program variables accessed inside a given transaction. The programmer can declare each group of variables as having one of four possible relaxed semantics. The group is no longer subject to the default atomicity constraints to which all shared variable and memory accesses are subjected to within a transaction.

A group is a declarative construct that a programmer can include at the beginning of the code for an RSTM transaction. A group is a collection of named program variables that could be concurrently accessed from multiple threads. The following C code example illustrates how to define groups:

```
extern int a, b, c, d; /* global variables * /
int i = ...;
atomic A(i) {
  group (a, b) : consistency-modifier;
  ...
}
```

In this code example, A is the label assigned to the transaction by the programmer. Transaction A could be running concurrently in multiple threads. The A(i) representation allows the programmer to refer to a specific running instance of A. The programmer is responsible for using an appropriate expression to compute i in each thread so that a distinction between multiple running instances of A can be made. For example, if there are N threads, then i could be given unique values between 0 and N−1 in the different threads. A would refer to any one running instance of transaction A, whereas A(i) would refer to a specific running instance. In all subsequent discussion, the label Tj could refer to either form.

Types of Consistency Modifiers: For the consistency-modifier field in the previous code example, the programmer could use one of the following: (1) none: Perform no consistency checking on this set of variables. Other transactions could have modified any of these variables after the current transaction accessed them, but the current transaction would still commit (provided no other conflicts unrelated to variables a and b are detected). (2) single-source (T1,T2, . . . ): The variables a and b are allowed to be modified by the concurrent execution of exactly one of the named transactions without causing a conflict at the commit point of transaction A. T1, T2, etc are labels identifying the named transactions. (3) multi-source (T1,T2, . . . ): Similar to single-source, except that multiple named transactions are allowed to modify any of the variables in the group without causing a conflict at commit point of A.

Progress Indicators: A programmer can declare progress indicators at points inside the code of a transaction. A counter would get associated with each progress indicator. The counter would get incremented each time control-flow passes that point in the transaction. If the transaction is not currently executing, or has started execution but not passed the point for the progress indicator, then the corresponding counter would have the value −1. Each instance of a running transaction gets its own local copies of progress indicators. Other transactions can monitor whether the current transaction is running and how much progress it has made by reading its progress indicators. The progress indicator values are only pushed out from the current transaction on a best-effort basis. This is to minimize stalling and communication overheads, while still allowing other transactions to use possibly out-of-date values to determine a lower-bound on the progress made by the current transaction. The following code sample shows how Progress Indicators are specified in a transaction:

```
atomic A(i) {
  for(j=0;j <N; j++) {
    ...
    progress indicator x;
    if (. . .)
      progress indicators y;
  }
}
```

In this example, the progress indicator x is incremented in each iteration of the loop. A special progress indicator called status is pre-declared for each transaction. status =−1 implies that the transaction is not running or it aborted, =0 means that it is currently executing, =1 means that the transaction is currently waiting to commit. Updates to the status progress indicator are immediately made available to all monitoring transactions as this is expected to be the most important progress indicator they would like monitor. Progress indicators can be monitored from transactions running in other threads.

One C++ API that may be used by the programmer is as follows:

atomic B {if ( A(2). status == 0&&A(2) .x <= 50 ) {
/* do some extra redundant computation * /
}else /* { speculatively skip redundant computation
* /
}}
/* Now check global state to determine if A(2)
actually committed its extra computation , or if B
did the extra computation .
If neither , then recover by doing the extra
computation now (hopefully , this will be relatively
rare) .
* / }

The RSTM implementation includes the following parts: (1) STM Manager is a unique object that keeps track of all running and past transactions. It also keeps the master book-keeping for all memory regions touched by a transaction. It acts as the contention manager for the RSTM system. This object is the global synchronizing point for all book-keeping information in the system. (2) STM Transaction is the transaction object. It provides functions to open variables for read, write-back values and commit. (3) STM ReadGroup groups variables that belong to the same read group. STM ReadGroups are associated with a transaction. STM ReadGroups are re-created every-time a transaction starts and are destroyed when the transaction commits. (4) STM WriteGroup groups variables that have a particular write consistency model associated with them. They are similar to STM ReadGroup.

One embodiment employs zoned management which help relieve the storage overhead associated with book-keeping at a byte level. We also propose some interesting optimizations to the runtime to allow it to prioritize transactions and intelligently manage transaction commits.

Zone-based management: A zone is defined as a contiguous section of memory with the same metadata. Metadata, in our case, is the version number and the information regarding the last transaction that wrote to the memory region. Zones dynamically merge and split to maintain the following two invariants: (1) All bytes within a zone have the same metadata. (2) Two zones that are contiguous but separate differ in metadata. The first invariant guarantees correctness because the properties of an individual byte are well-defined and easily retrievable. The second invariant guarantees that the bookkeeping information will be as small as possible.

Zones are an implementation mechanism designed for minimizing the bookkeeping information. They have no implication on the functionality of the STM. To the user, the use of zones or the use of a byte-level book-keeping is equivalent. The same information can be obtained in both cases.

STM Memory Manager: The API provided by the STM Memory Manager allows zone management of the memory. The API provides the following access points: (1) Retrieve properties for a zone. The programmer can request the version and last writer of any arbitrary zone of memory. The zone can be one byte or it can be a larger piece of contiguous memory. It does not have to match zones used internally to represent the memory. (2) Set properties for a zone. Similarly, properties such as version number and last writer can be set for any arbitrary zone of memory. (3) Zones query. Allows the programmer to determine whether a zone is being tracked or not. Thus, the API allows for a view of memory at a byte level while maintaining information at a zone level. The exact way in which information is stored is abstracted away from the programmer.

The STM Manager object provides three main functions to the user. The STM Manager needs to know about transactions as it needs to know about which transactions may potentially commit in order to perform certain optimizations. This is the reason why transaction objects are obtained from the STM Manager directly. The other two functions are used when committing transactions. When a transaction commits, it has to check atomically if anyone has written to where it wants to write and lock the location. When a transaction has obtained a lock on a memory location, any other transaction trying to write back its value to that zone will fail and have to either wait or retry. This thus guarantees that all the writes from a given transaction occur atomically with respect to writes from other transactions.

The STM Transaction object implements the main functionalities common in all STM systems. It further adds support for relaxed semantics. The main API is described in the following:

void commit( );
void openForRead( void * loc , unit size ,
list<STM ReadGroup* > groups);
void writeBack( void * loc , unit size ,
void * data, STM WriteGroup* group);

The ‘openForRead’ function opens a variable for reading and puts it in the specified STM ReadGroups. The groups are then responsible for enforcing their particular flavor of consistency. The ‘writeBack’ function opens a variable for write and buffers the write-back. ‘commit’ will try to commit the transaction by checking if all of the read groups can commit and if the variables can be written back correctly.

The STM ReadGroup allows specification of the majority of the relaxed semantics. The programmer can specify the type of consistency a read group will enforce.

The commit of a relaxed transaction is very similar to that of a regular transaction. However, certain consistency checks are skipped due to relaxation in the model. The following steps are performed when committing a transaction: (1) Check to make sure if the default read group can commit. This group enforces traditional consistency for all variables that are not part of any other group. Therefore, all variables in the default group must not have been modified between the time they are read and the time the transaction commits. (2) Check to make sure if read groups can commit. This will implement the relaxed consistency model previously discussed. Read groups can commit under certain conditions even if the variables they contain have been modified.

Committing a read group is simply a matter of enforcing the consistency model of the group on the variables present in the group. Checks are made on each zone that is present in the read group to see if they have been modified, and, if they have, if it is still correct to commit given the relaxed consistency model.

Committing a write group includes: (1) acquiring a lock from the STM Manager on all locations the group wants to update; (2) checking to make sure that there were no intermediate writes; (3) writing back the buffered data to the actual location; (4) updating the version and owner information for the locations updated; (5) unlocking the locations and releasing the space acquired by the buffers (now useless).

Write groups can also still presume that they have successfully committed even if there was a version inconsistency provided that it was within the bounds indicated by the relax consistency model. Note that in the case of a version mismatch that is acceptable, the buffered value is not written back.

Since the system employs a zone-based book-keeping scheme, it should minimize the number of zones. Therefore, when a write group commits, it will set the version of all the zones it is committing to the same number. This new version number will be greater than all the old version number for all the zones being updates. This ensures correctness also allows for the minimization of the number of zones that will be used for the write group. Since the properties for the zones are all the same (same last writer and same version), all contiguous zones will be merged. While this may not be the optimal solution to obtain the minimum number of zones globally, it does try to keep the number of zones low.

The system implements some prioritization based optimization in the runtime. The basic idea is that transactions will higher priority and a near completion time should be allowed to commit before transactions with a lower priority that may already be trying to commit. The STM Manager will try to factor this into account. It does this by stalling the call to ‘getVersionAndLock’ of a lower priority thread A if the following two conditions are met:

A higher priority thread (B) has segments intersecting with those of A

B is close to committing.

It will thus let the other transaction (B) commit and then will allow A to proceed. A timeout mechanism is also present to prevent complete lack of forward progress.

Each of the time steps should result in exactly one set of updates to the particles' attributes. This is placed in the body of an atomic block, and the current time step or iteration count is exported as a Transaction State. The transaction Ti declares the particle attributes of its neighboring transactions Ti−1 and Ti+1 to be in its read-group. It then uses these values to compute the new attributes of its own particles. Finally, it tries to commit these values and if a consistency violation is detected, it aborts and retries. The intuition to the relaxation of consistency here is that particles that are far away from a particle p, do not exert much force on it whereas particles in the blocks neighboring that of p, do exert a significant force on p. Thus, in the calculation of the force vector for each p in block i, read consistency is followed only when reading positions of particles in neighboring blocks i−1 and i+1. Even though the positions of particles in other blocks are also read, they are not added to a ReadGroup and hence are not check for consistency violation at commit time, since reading somewhat stale positions of such distant particles will not affect the accuracy of the calculation much. Also, even for nearby particles, the relaxation model accepts a certain staleness (one time step ahead or behind). This relaxation is achieved by using the progress indicators and group consistency modifiers. Each transaction updates its progress indicator at the boundary of each time step. A transaction wishing to read the particle positions owned by another transaction will add the latter to its group consistency transaction list. If the producer transaction is the owner of a cell close to the one owned by the consumer transaction, the producer is added to the group consistency list with the single-source or multi-source modifiers.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method of dynamically changing a computation performed by an application executing on a digital computer, comprising the actions of:
a. characterizing the application in terms of slack and workloads of underlying components of the application and of interactions therebetween;
b. enhancing the application dynamically based on the results of the characterizing action and on dynamic availability of computational resources; and
c. adjusting strictness of data consistency constraints dynamically between threads in the application, thereby providing runtime control mechanisms for dynamically enhancing the application.

2. The method of claim 1, wherein the characterizing action comprises the actions of:
a. performing a profiling analysis of the application; and
b. performing a statistical correlation and classification analysis of the application, thereby generating a prediction model of the application to predict future workload and slack associated with components of the application.

3. The method of claim 2, further comprising the action of performing a program analysis of the application, thereby enhancing an accuracy of a prediction model in predicting future workload and slack associated with application components.

4. The method of claim 1, wherein the characterizing action comprises the actions of generating a low overhead model of the application for dynamic prediction of computational resource workload and slack during execution of the application.

5. The method of claim 1, wherein the characterizing action comprises the actions of:
a. determining patterns of execution of the underlying components in the application that can be reliably predicted in terms of slack and workloads;
b. determining signatures for detection of the patterns and corresponding specific properties regarding expected execution profiles of the underlying components; and
c. generating a pattern detection and prediction mechanism for the application to facilitate dynamic detection and prediction of the patterns during execution of the application.

6. The method of claim 1, wherein the characterizing action comprises off-line profiling of the application to generate a statistical model of the application.

7. The method of claim 6, further comprising the action of, during off-line profiling, making hierarchical queries to try out different what-if scenarios to determine corresponding effects on the application, thereby allowing in-loop modification and performance estimation of the underlying components of the application.

8. The method of claim 6, wherein the characterizing action comprises on-line profiling and learning of the application during execution to refine the statistical model.

9. The method of claim 1, wherein the characterizing action comprises profiling the application to:
a. determine cause-effect relationships during debugging of performance bottlenecks; and
b. identify slack that can be used in executing opportunistic soft-real-time computation.

10. The method of claim 1, wherein the characterizing action comprises the action of projecting performance implications of additional functionalities of the application and the availability of additional resources to systems having varying core counts to determine how the application will scale with respect to the varying core counts.

11. The method of claim 1, wherein the enhancing step comprises increasing a frame rate.

12. The method of claim 1, wherein the enhancing step comprises employing a higher level of compression.

13. The method of claim 1, wherein the enhancing action comprises receiving input from a programmer indicative of:
a. additional computation that is to be executed under a predetermined soft-real-time condition;
b. desired statistical behaviors of predetermined computational units within the application; and
c. desired correctness constraints under which the application is to operate.

14. The method of claim 13, wherein the predetermined soft-real-time condition comprises detection of a predetermined level of slack in a component of an application.

15. The method of claim 1, wherein the enhancing action comprises the actions of:
a. monitoring the application and detecting slack; and
b. applying an enhancement paradigm to the application in response to the detecting of slack.

16. The method of claim 15, wherein the enhancement paradigm comprises refining a calculation.

17. The method of claim 15, wherein the enhancement paradigm comprises extending the application to a larger data domain.

18. The method of claim 15, wherein the enhancement paradigm comprises executing additive computation over a base computation performed by the application.

19. The method of claim 1, wherein the enhancing action comprises the action of attaching variable semantics to the application, thereby scaling quality of results with respect to availability of computational resources and existence of slack.

20. The method of claim 1, wherein the action of adjusting strictness of data consistency constraints comprises the action of employing a centralized data-commit management module to provide transparent resolution of thread data conflicts within the application.

21. The method of claim 1, wherein the action of adjusting strictness of data consistency constraints comprises the actions of:
a. grouping data into shared-data groups; and
b. relaxing data consistency properties of the shared data groups, thereby lowering conflicts among threads sharing data.

22. The method of claim 1, wherein the action of adjusting strictness of data consistency constraints comprises the action of specifying a type of consistency within a range of no data consistency to strict data consistency.

23. The method of claim 22, further comprising the action of varying the type of consistency dynamically.

24. The method of claim 1, wherein the action of adjusting strictness of consistency constraints comprises the action of specifying loose synchronization with respect to control between several concurrently executing threads.

25. The method of claim 1, wherein the action of adjusting strictness of consistency constraints comprises the action of allowing threads to proceed in a controlled asynchronous manner by allowing a first thread to lead a second thread so that a loose-barrier is not violated, wherein a loose-barrier is a barrier between threads that allows control-flow in concurrent threads to run ahead or behind other concurrent threads by at most a number of time steps determined from programmer-specified constraints.

26. The method of claim 25, wherein the action of allowing threads to proceed in a controlled asynchronous manner comprises the action of allowing a first thread to read stale values of shared date and continue instead of blocking at a thread barrier and waiting for a second thread to reach a corresponding barrier.

27. The method of claim 26, wherein the action of adjusting strictness of consistency constraints comprises the action of controlling staleness of values and atomicity requirements by adjusting a selected one of a lead or a lag in an execution progress between the first thread and the second thread.

28. A method of characterizing an application, configured to execute on a digital computer, in terms of slack and workloads of underlying components of the application and of interactions therebetween, comprising the actions of:
a. performing a profiling analysis of the application; and
b. performing a statistical correlation and classification analysis of the application, whereby the profiling analysis and the statistical correlation and classification analysis result in characterization of the application.

29. The method of claim 28, further comprising the actions of:
a. determining patterns of execution of the underlying components in the application that can be reliably predicted in terms of slack and workloads;
b. determining signatures for detection of the patterns and corresponding specific properties regarding expected execution profiles of the underlying components; and
c. incorporating a pattern detection and prediction mechanism in the application to facilitate dynamic detection and prediction of the patterns during execution of the application.

30. The method of claim 28, further comprising the action of performing a program analysis of the application, thereby enhancing accuracy of a prediction model in predicting future workload and slack associated with application components.

31. A method of enhancing an application, configured to execute on a digital computer, dynamically, comprising the actions of:
a. monitoring the application and detecting slack; and
b. applying an enhancement paradigm to the application in response to the action of detecting slack.

32. The method of claim 31, wherein the enhancement paradigm comprises refining a calculation.

33. The method of claim 31, wherein the enhancement paradigm comprises extending the application to a larger data domain.

34. The method of claim 31, wherein the enhancement paradigm comprises executing additive computation over a base computation performed by the application.

35. The method of claim 31, further comprising the action of attaching variable semantics to the application, thereby scaling quality of results with respect to availability of computational resources and existence of slack.

36. The method of claim 31, further comprising the actions of:
a. receiving input from a programmer specifying quality objectives at a plurality of levels of hierarchy in the application;
b. dynamically deriving the quality objectives at a plurality of points in the application, thereby achieving higher level quality objectives; and
c. dynamically adjusting computation of the application to meet the quality objectives.

37. A method of adjusting strictness of consistency constraints dynamically between threads in an application configured to execute on a digital computer, comprising the actions of:
a. grouping data shared between threads into shared-data groups; and
b. relaxing data consistency properties of the shared data groups thereby lowering conflicts among threads sharing data; and
c. utilizing lowering of conflicts between threads to provide additional flexibility for enhancing the application dynamically to meet enhancement objectives, subject to correctness constraints provided by a programmer.

38. The method of claim 37, further comprising the actions of:
a. specifying a type of consistency within a range of no consistency to strict consistency; and
b. varying the type of consistency dynamically.

39. The method of claim 37, further comprising the actions of:
a. specifying loose synchronization with respect to control between several concurrently executing threads, thereby specifying at least one loose synchronization barrier; and
b. allowing threads to proceed in a controlled asynchronous manner by allowing a first thread to lead a second thread so that the loose synchronization barrier is not violated.

40. A method of computing an application on a digital computer, comprising the actions of:
determining a probabilistic model that execution units of the application will exhibit slack during execution of the application on at least one computational unit; and
utilizing the probabilistic model to enhance the application when the model predicts that future execution of an execution unit is expected to exhibit a desired amount of slack.

41. The method of claim 40, wherein the computational resource comprises a processor of a plurality of parallel processors.

42. The method of claim 40, wherein the computational resource comprises a core in a multi-core system.

43. The method of claim 40, further comprising the action of profiling the application to identify a plurality of executable units within the application.

44. The method of claim 43, wherein the detecting action comprises statistically analyzing each of the plurality of executable units so as to determine a probabilistic model relating thereto.

45. The method of claim 44, wherein the profiling action comprises:
a. assigning each of the plurality of executable units into a plurality of nodes, wherein a sequencing and organization of the nodes captures an order of execution of a plurality of execution units in terms of:
i. statistics collected at program runtime; and
ii. constraints determined by program analysis;
b. executing the application with units of representative test inputs to generate an offline profile of the application; and
c. employing statistical correlation and classification techniques to compile a statistical description regarding execution of each node.

46. The method of claim 45, further comprising the action of identifying a runtime-detectable signature for each node.

47. The method of claim 46, wherein the action of causing the computational resource to execute additional code comprises:
a. detecting a signature for a node that has a desired probability of inducing slack in a computational resource; and
assigning additional computations to available computational resource, including one on which an execution unit exhibits slack, the additional computations including code that results in enhancement of the application.

48. The method of claim 47, wherein the enhancement comprises performing extra work.

49. The method of claim 48, wherein the action of performing extra work comprises calculating an increased level of detail.

50. The method of claim 48, wherein the action of performing extra work comprises calculating extra iterations of an iterative computation.

51. The method of claim 48, wherein the action of performing extra work comprises changing from a less complex computational model to a more complex computational model.

52. The method of claim 48, wherein the action of performing extra work comprises dynamically changing execution of a segment of code to perform a different task.

53. The method of claim 48, wherein the action of performing extra work comprises injecting code to add a feature.

54. The method of claim 53, wherein the application is directed to a model of a physical phenomenon and wherein the action of injecting code comprises adding code that models a parameter not originally included in the model.

55. A method of opportunistic computing of an application on a digital computer, comprising the actions of:
a. profiling the application so as to determine execution properties of a plurality of executable units in the application;
b. statistically analyzing the plurality of executable units to identify a plurality of indicators in the application, wherein each indicator indicates when a computational resource will exhibit slack with a desired probability when executing a corresponding executable unit;
c. detecting one of the indicators during the execution of the application and thereby identifying a computational resource in which slack has been predicted with a desired probability; and
d. employing the computational resource identified in the detecting step, and other available computational resources, to execute an extended executable unit to enhance the application.

56. The method of claim 55, further comprising the actions of:
a. specifying a quality objective relating to an execution of the application; and
b. ensuring that the quality objection is met during execution of the application.

57. A method of generating code for an application designed to execute on a digital computer, comprising the actions of:
a. encoding a primary set of instructions necessary for the application to operate at a basic level;
b. generating a secondary set of instructions that include enhancements to the primary set of instructions; and
c. indicating in the application a plurality which of the secondary set of instructions are to be executed in response to a runtime indication that a computational resource is underutilized.

58. The method of claim 57, further comprising the actions of:
a. organizing the primary set of instructions so as to be associated with a plurality of nodes, each node corresponding to a separate instance of a function call; and
b. adding to each node an entity that facilitates tracing execution of the node in a code analysis entity.
